(19) United States
(12) Patent Application Publication
(10) Pub. No.: US 2021/0390874 A1
(43) Pub. Date: Dec. 16, 2021

(54) COCKPIT VIBRATION SYSTEM FOR SIMULATOR

(71) Applicant: THALES, COURBEVOIE (FR)

(72) Inventors: Rémy DISPAGNE, Cergy Pontoise (FR); Maxime BONNET, Versailles (FR); René LE GUILLOU, Maurepas (FR)

(21) Appl. No.: 17/285,436

(22) PCT Filed: Oct. 17, 2019
(86) PCT No.: PCT/EP2019/078230

§ 371 Date: Apr. 14, 2021

(30) Foreign Application Priority Data
Oct. 18, 2018 (FR) 1801100

(51) Int. Cl. G09B 9/12; G09B 9/46; G09B 9/16

(52) U.S. Cl. CPC G09B 9/12; G09B 9/16; G09B 9/46

(57) ABSTRACT

A vibration system for a simulator cockpit which includes at least one pilot seat. The vibration system comprises a vibration module for the pilot seat, the seat vibration module being composed of a platform having a top face to which the pilot seat is fixed and a bottom face to which a motor drive system is coupled. The motor drive system comprises independent mechanical means allowing the platform to be made to vibrate on three orthogonal axes, and is coupled to a control module configured to independently actuate each mechanical means and vary, in real time, the amplitude of the vibratory movements of the platform on each orthogonal axis.

### TECHNICAL FIELD

The invention relates to the field of simulators, in particular that of aeronautical simulators, and proposes a cockpit vibration system.

### STATE OF THE ART

The vibrations that exist onboard an airplane are omnipresent, and in a cockpit which contains numerous items of equipment such as seats, the instrument panel, the controls, they are significant. Simulating the existing vibrations in a cabin or cockpit needs to allow the real vibrations to be reproduced and, for an aircraft simulator, the reproduction is subject to stringent standards.

One example is that of the “level D” certified helicopter simulators, for which the standards EASA CS-FSTD(H) or FAA 14CFR part 60 demand observance of the vibration spectrum of the helicopters in a differentiated manner in the 3 axes XYZ and on each of the seats. The reference for approving conformity of the vibrations is measured under the pilot seat. The frequencies of the vibrations demanded cover a wide frequency range, generally from 5 to 35 HZ.

Vibration system solutions for aircraft simulators usually used consist in making all of the cockpit vibrate. FIG. 1 schematically illustrates a cockpit of a simulator (100) equipped with a vibration system (102) which aims to make all the cockpit vibrate. In this solution, the actuators which make it possible to make all the cockpit vibrate, three of them in the example, are separated from the cockpit. As shown in the figure, the overall center of gravity ‘G’ is then too high with respect to the vibration system. In addition, such a vibration system delivers a 6-axis movement which is ill-suited to the vibrations. In fact by making all of the cockpit vibrate, the various subassemblies such as the instrument panel or controls are subjected to vibrations and to resonances that are not controlled. The result thereof are stray resonances and it is then impossible to differentiate the axes X, Y and Z and therefore reproduce the requisite accelerations in the three axes XYZ.

Furthermore, given the mechanical resonances and the lack of rigidity of the transmission elements, including the compartment, the flight controls, the pallets, it is not possible to obtain the desired accelerations on each of the subassemblies of the cockpit (the seats, the instrument panel, the controls). To remedy this, it would be necessary to have extremely rigid structures which, in counterpart, would result in excessively high resonance frequencies, and would render such a solution inapplicable to a complete assembly such as an aircraft cockpit.

Moreover, another demand for the simulators is that the environment, which is often a visual system which is sensitive to vibrations, must not be disturbed. Since the vibrations are generated on a system which itself is in motion, it vibrates a significant mass which, by feedback, makes all of the structure vibrate. It is therefore desirable to have a vibration system which works independently of its position in space and of the accelerations to which it can be subjected.

Other vibration system solutions for aircraft simulators consist in making only the seat of the pilot vibrate on the three axes XYZ. FIG. 2 schematically shows an aircraft simulator (200) equipped with a vibration system (202) which allows the seat of the pilot to be made to vibrate. Although widely used, this system cannot be certified. Indeed, according to the international standards, the cockpit or the platform must be made to vibrate because the pilot needs to feel, on the one hand, the vibrations at the seat but also at the feet and the instruments. Now, this solution is composed of accelerometers placed on the floor of the cockpit, and makes neither the feet which are a significant part of the sensations of the pilot, nor the stick, nor the components of the environment of the cockpit vibrate. Moreover, the seat and the pilot are subjected to stray vibrations which do not allow objective measurements to be performed because, for reliability reasons, the data can be recorded only under the seat. It is therefore desirable to have a vibration system which allows the measurements on the floor to be taken so as not to be disturbed and which at the same time allows all the vibrations to be taken into account.

The patent application EP 2246832 A1 presents a vibration system for a simulator which consists in making the seat of the pilot, the stick and the control system vibrate by virtue of small eccentric weights which rotate at a certain speed that makes it possible to have the desired frequency. To generate the vibrations on the seat, the eccentric mass is fixed under the seat, the motor for rotating this mass bearing on the back of the seat which, by feedback, makes it vibrate. The speed of the motor can vary, but it is not possible to modify the weights in real time and it is therefore not possible to make the amplitude of the vibration vary. Moreover, the vibration generated is not directional. Indeed, the eccentric weight makes all of the seat vibrate and has no priority direction. So, such a solution cannot be certified as “level D” because the vibration system which acts on the seat does not allow for independent control of the three axes X, Y or Z and does not allow the amplitude to be made to vary in real time. Now, the measurements for certification for a helicopter for example are performed on the floor under the seat, because a measurement on the seat is too dependent on non-representative localized factors, such as the resonance frequency of the seat or even the position of the pilot.

So, the present invention proposes a solution which addresses the various abovementioned needs.

### SUMMARY OF THE INVENTION

One object of the present invention is to propose a system which allows vibrations to be generated for an aircraft simulator. Advantageously, the system of the invention allows the real vibrations that exist in an aircraft cockpit to be reproduced.

The general principle for making all of the cockpit vibrate consists in equipping the cockpit with a modular vibration system comprising several independent vibration modules (for example one module for the pilot part, one module for the copilot part, one module for the instrument panel and the pedestal) and in which each module can be implemented individually. Each module is placed as close as possible to the zone where the vibrations have to be generated and, through appropriate kinematics, each element can vibrate in the three axes (X, Y, Z) independently and with variable amplitudes and frequencies. Thus, for the pilot part, a module is arranged under the seat of the pilot. This pilot module comprises a platform to which the seat and the support of the pilot seat are fixed, and a motor drive system with actuators situated under the platform which are adapted to make all the platform vibrate in the 3 axes independently, with variable amplitudes and frequencies. The instrument panel and the pedestal each have a simplified vibration system which allows the correct amplitude level to be obtained independently.

The advantages of this novel vibration system that must be cited include:
the precision: the vibration system is precise for each module. For the pilot and the copilot, the systems are independent and the actuators are placed directly under the seats, allowing acceleration under each seat to be controlled.
the low impact on the environment: the system reduces the disturbances on the environment. Since the weights involved are small, there is very little repercussion on the environment, like the visual environment. Furthermore, the stray vibrations are filtered by the cockpit compartment. Moreover, each module can be controlled in phase opposition and thus cancel the repercussions on the visual environment.
the overall bulk which is reduced.
the certification: the system conforms to the requirements for a “level D” certification in the field of simulation.

To this end, the subject of the invention is a vibration system for a simulator cockpit which comprises at least one pilot seat. The vibration system comprises a vibration module for the pilot seat, the seat vibration module being composed of a platform having a top face to which the pilot seat is fixed and a bottom face to which a motor drive system is coupled. The motor drive system comprises independent mechanical means allowing the platform to be made to vibrate on three orthogonal axes, and is coupled to a control configured to independently actuate each mechanical means and make the amplitude of the vibratory movements of the platform vary in real time on each orthogonal axis.

According to alternative or combined embodiments:

the system also comprises a vibration module for an instrument panel coupled to the instrument panel of the cockpit, the instrument panel vibration module being actuated to make the instrument panel vibrate, autonomously and independently of the seat vibration module;

the system also comprises a vibration module for a pedestal coupled to the pedestal of the cockpit, the pedestal vibration module being actuated to make the pedestal vibrate, autonomously and independently of the seat vibration modules;

the system also comprises a pedestal vibration module coupled to the pedestal of the cockpit, the pedestal vibration module being actuated to make the pedestal vibrate, autonomously and independently of the instrument panel vibration module;

the cockpit further comprises a copilot seat, and the vibration system comprises a vibration module for said copilot seat;

the control module is configured to control the vibration module of each pilot seat and copilot seat in phase opposition;

the motor drive system is hydraulic or electrical;

the platform is made from a rigid material.

The invention also covers a helicopter simulator which comprises at least one seat vibration system as claimed.

More generally, the invention relates also to an aircraft simulator which comprises a cockpit vibration system as claimed.

### DESCRIPTION OF THE FIGURES

Different aspects and advantages of the invention will emerge in support of the description of a preferred, but nonlimiting, mode of implementation of the invention, with reference to the figures below:

FIG. 1 schematically illustrates a cockpit of a simulator equipped with a known vibration system;

FIG. 2 schematically illustrates a cockpit of a simulator equipped with another known vibration system;

FIG. 3 schematically illustrates an aircraft simulator cockpit floor that can be equipped with two seat vibration modules in an embodiment of the vibration system of the invention;

FIG. 4 schematically illustrates two seat vibration modules in an embodiment for equipping the floor of an aircraft simulator cockpit;

FIG. 5 schematically illustrates the motor drive system of a seat vibration module on one of the three axes in one embodiment; and

FIG. 6 shows, by interior view, an aircraft cockpit that can be equipped with vibration modules according to the invention; and

FIG. 7 shows, from another interior view, an aircraft cockpit equipped with instrument panel vibration modules.

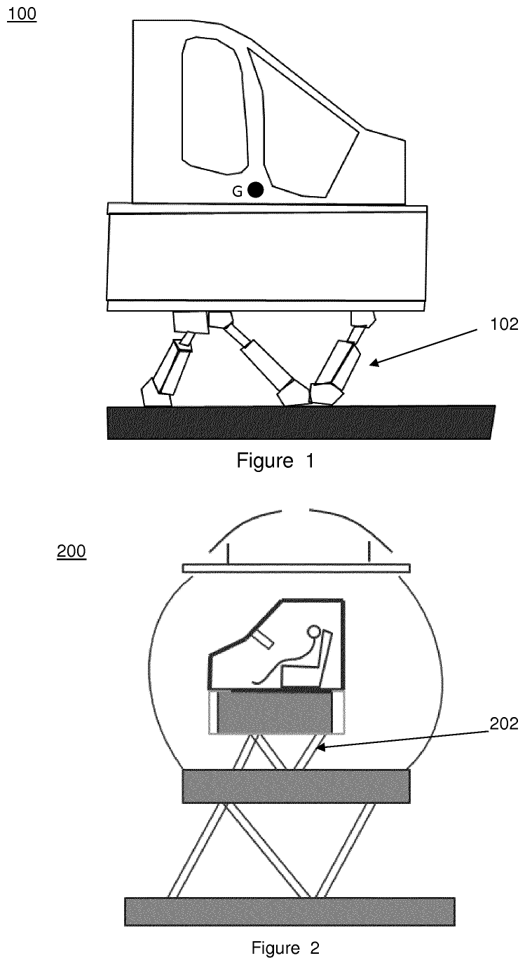

### DETAILED DESCRIPTION OF THE INVENTION

Generally, the invention proposes a system which consists in generating vibrations on each element in an aircraft cockpit having to reproduce real vibrations. The proposed solution comprises independent vibration systems for the pilot and for the copilot and separate vibration systems for the other elements or subassemblies of a cockpit, such as the instrument panel or the pedestal.

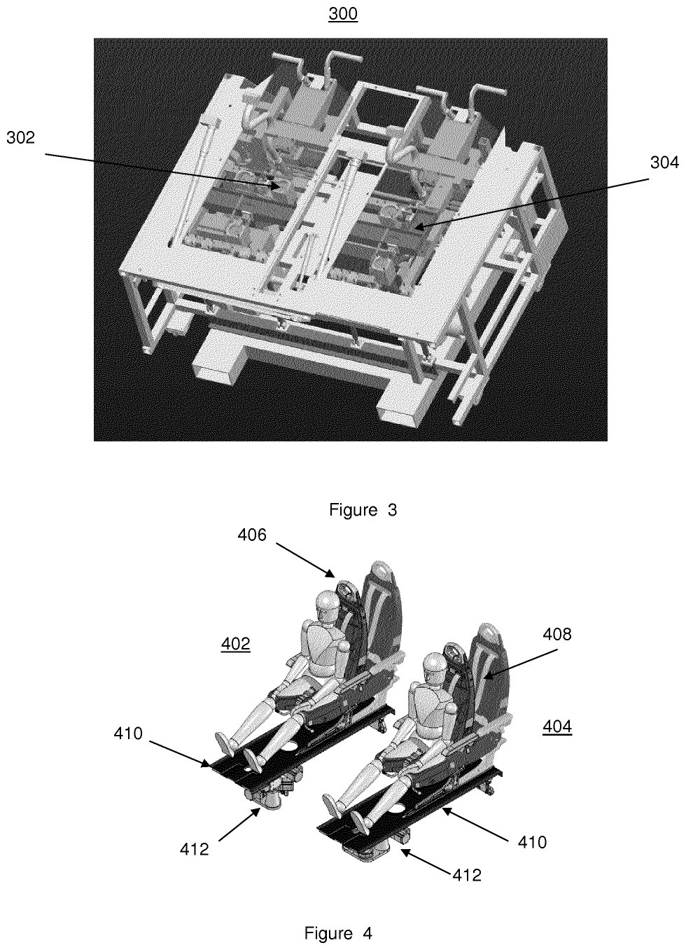

FIG. 3 schematically illustrates a floor (300) of an aircraft simulator cockpit that can be equipped with two vibration modules, respectively in each location of the pilot (302) and copilot (304) seats. Although the configuration illustrated shows a cockpit with two seats, the principle described applies to any single-seat cockpit or for a two-seat cockpit but occupied only by a single pilot.

FIG. 4 schematically illustrates a seat vibration module in an embodiment. The example shows two seat vibration modules (402, 404) for equipping the floor of an aircraft simulator cockpit like that of FIG. 3 for example.

A seat vibration module according to the invention is assigned to each seat (406, 408), one module for the pilot seat and one module for the copilot seat. In fact, advantageously, the independence of the vibration modules allows each module to be controlled separately, with a vibration kinematic dedicated to each module. In a cockpit configuration with two seats but occupied only by a pilot, it becomes possible to apply differentiated vibrations to the occupied seat and to the empty seat, allowing the pilot to be provided with greater realism.

Moreover, by controlling each seat separately, it is possible to control them in phase opposition, and thus reduce the disturbance generated by the vibrations on the surrounding systems, such as the visual environment.

A seat vibration module (402 or 404) is composed of a platform (410) having a top face on which the seat (406 or 408) is installed, and a bottom face to which a motor drive system (412) is coupled. As represented in FIG. 4, the seat is mounted on a seat support which is fixed to the platform, and which allows the seat to be slid on a horizontal plane in order to adapt to the morphology of the pilot.

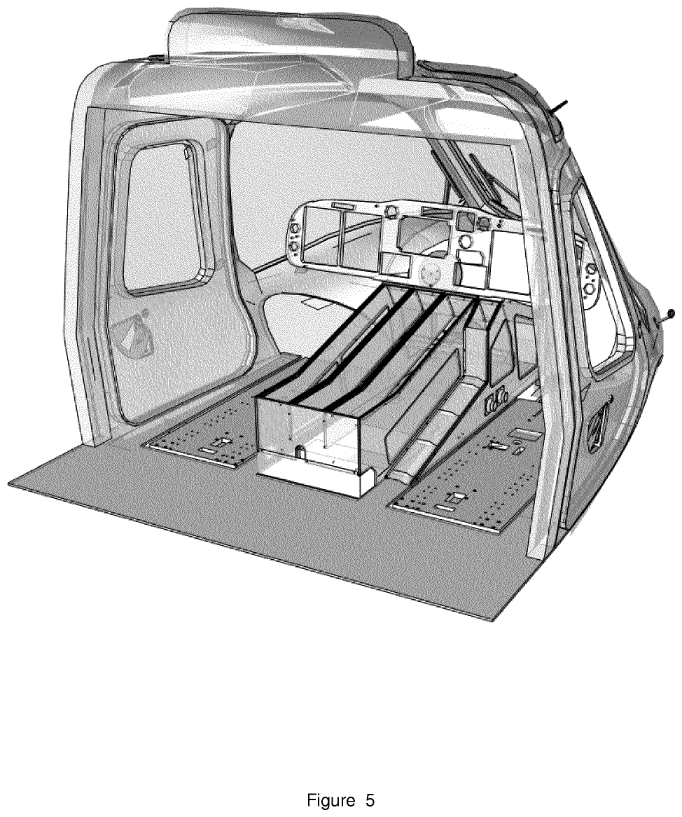

The platform, once installed in its location (302, 304), forms part of the floor of the cockpit. FIG. 5 shows an interior view of an aircraft cockpit that can be equipped with vibration modules according to the invention.

The motor drive system (412) situated under the platform, comprises independent actuator blocks which allow the platform (410) to be made to vibrate on three orthogonal axes (X, Y, Z). In one embodiment of the three-axis vibration platform, each actuator block comprises mechanical means of motor, power and link rods type arranged so as to be able to apply vibrations to the front and to the back of the platform on an axis of vibration dedicated for each. Such an arrangement is for example described in the patent application FR 2 684 316 A1 from the applicant.

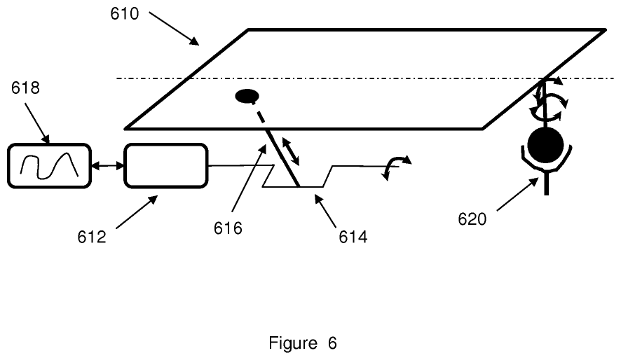

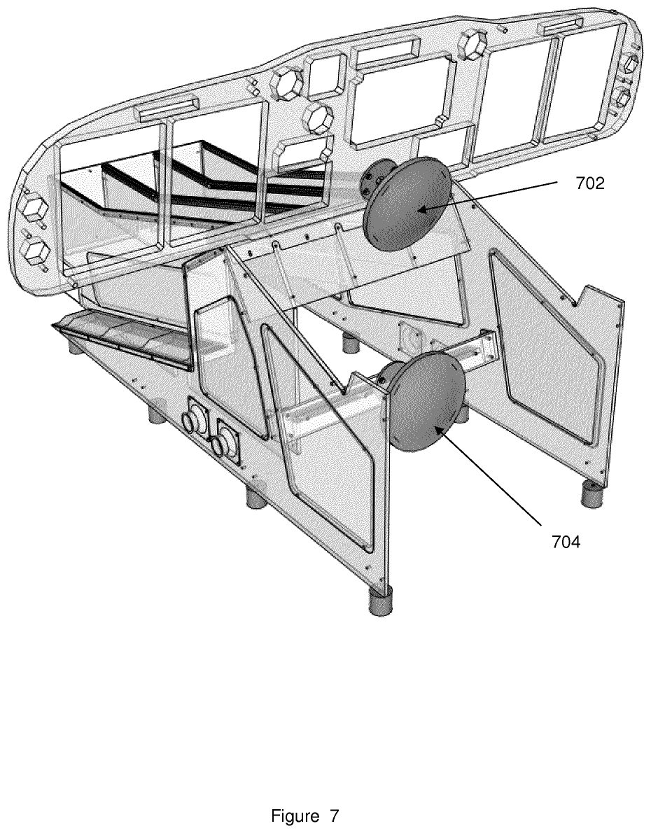

The motor drive system is coupled to a control module which is configured to independently control each actuator block, make the motor output oscillate, and thus displace the platform on the corresponding axis. FIG. 6 very schematically illustrates the principle of control of a single actuator block to make the platform (610) vibrate on one of the three axes, comprising a mechanical arrangement having at least one motor (612) driving a shaft-type axis with cam or eccentric (614), a rigid link (616) between the cam (614) and the floor (610), and a link of ball joint type (620) supporting also the floor (610). The complete motor drive system comprises three actuator blocks equivalent to that described, each actuating a degree of freedom corresponding to each of the three axes. The motor drive system of the platforms can be hydraulic or electrical. In one embodiment, the motor drive system is produced by electric motors with eccentric and transmission by link rods to avoid clearances and limit friction.

One alternative embodiment of the vibration system with separate modules is to generate vibrations by specific loudspeakers. Nevertheless, in this case, vibrations cannot be differentiated between the three axes (X, Y, Z) and such a solution cannot be certified.

Advantageously, each actuator block is controlled independently by a signal (618) computed by modeling of the vibrations of the simulated platform, and which allows the amplitude and the frequency of the vibratory movements of the platform to be varied in real time on the axis of vibration of the actuator block being controlled. By reproducing, under the platform, the vibrations in the three axes, the true vibrations of an aircraft are transmitted to the pilot seat and to the feet of the pilot.

Preferentially, the platform is produced in a rigid material in order not to have resonances. Advantageously, that makes it possible to differentiate the vibrations in the three axes (X, Y, Z). Moreover, since the weights involved are small, that makes it possible to have a compensation of the weight by elastomer, and the vibrations are thus reflected only weakly on the visual environment.

The principle of the invention of having separate vibrating platforms for each pilot makes it possible to place, under each platform, accelerometers at the same point as in the real systems in order to validate the performance of the vibration system. The acceleration demanded is thus obtained at the exact point where the vibrations were recorded. In fact, the recordings on the real systems are performed by positioning the accelerometers under the pilot and copilot seats. That is not the case for the solutions with vibrating seat because the vibration is generated in the seat and cannot therefore be validated. Nor is it the case for the solutions with vibration of the complete cockpit because the vibrations are not managed for each seat. The supporting structure cannot be sufficiently rigid. It is then impossible to have the desired accelerations over the frequency spectrum and for the requested amplitude range. Thus, advantageously, the system of the invention allows the certification of the cockpit according to the FAA and EASA standards.

The vibration system for a simulator cockpit can comprise other means for vibrating the surrounding elements by adapting an independent vibration system for each element, such as the instrument panel and the pedestal which are vibrated by an autonomous vibrating system. FIG. 7 schematically illustrates another view of the interior of an aircraft cockpit equipped with vibration modules (702, 704) for the instrument panel and for the pedestal. The instrument panel vibration module (702) can be actuated to make the instrument panel vibrate, autonomously and independently of the seat vibration module.

This offers an advantage with respect to the known solutions which make the whole cockpit vibrate, and in which the vibration of the instrument panel for example is not controlled.

The pedestal vibration module (704) is coupled to the pedestal of the cockpit, and can be actuated to make the pedestal vibrate, autonomously and independently of the seat vibration module or modules, and of the instrument panel vibration module.

The present description illustrates a preferential but nonlimiting embodiment of the invention. In the context of the description, an aircraft simulator is understood to be a simulator of a transport means capable of moving around in the Earth's atmosphere. For example, an aircraft simulator can be an airplane or helicopter simulator. Thus, an example has been chosen to allow a good understanding of the principles of the invention, and a concrete application, but is not exhaustive and the description allows the person skilled in the art to provide modifications for other variant implementations. For example, the system in its variants will also be applicable to vehicle simulators.

1. A vibration system for a simulator cockpit, the cockpit comprising at least one pilot seat, the vibration system being installed inside the cockpit and comprising an independent vibration module coupled to each pilot seat, said pilot seat vibration module being composed of a platform having a top face to which the pilot seat is fixed and a bottom face to which a motor drive system is coupled, said motor drive system comprising independent mechanical means allowing the platform to be made to vibrate on three orthogonal axes, said motor drive system being coupled to a control module configured to independently actuate each mechanical means and make the amplitude of the vibratory movements of the platform vary in real time on each orthogonal axis.

2. The system as claimed in claim 1, also comprising a vibration module for an instrument panel coupled to the instrument panel of the cockpit, the instrument panel vibration module being able to be actuated to make the instrument panel vibrate, autonomously and independently of the pilot seat vibration module.

3. The system as claimed in claim 1, also comprising a vibration module for a pedestal coupled to the pedestal of the cockpit, the pedestal vibration module being able to be actuated to make the pedestal vibrate, autonomously and independently of the pilot seat vibration module.

4. The system as claimed in claim 2, also comprising a pedestal vibration module coupled to the pedestal of the cockpit, the pedestal vibration module being able to be actuated to make the pedestal vibrate, autonomously and independently of the instrument panel vibration module.

5. The system as claimed in claim 1, wherein the cockpit further comprises a copilot seat, and the vibration system further comprises a vibration module coupled to said copilot seat, the vibration module for copilot seat being composed of a copilot platform having a top face to which the copilot seat is fixed and a bottom face to which a motor drive system is coupled, said motor drive system comprising independent mechanical means allowing the copilot platform to be made to vibrate on three orthogonal axes, said motor drive system being coupled to said control module configured to independently actuate each mechanical means and vary, in real time, the amplitude of the vibratory movements of the copilot platform on each orthogonal axis.

6. The system as claimed in claim 5, wherein the control module is configured to control the vibration module of each pilot seat and copilot seat in phase opposition.

7. The system as claimed in claim 1, wherein the motor drive system is hydraulic or electrical.

8. The system as claimed in claim 1, wherein the platform is made from a rigid material.

9. A helicopter simulator comprising at least one seat vibration system as claimed in claim 1.

10. An aircraft simulator comprising at least one cockpit vibration system as claimed in claim 1.
